(19) United States
(12) Patent Application Publication
(10) Pub. No.: US 2006/0188728 A1
(43) Pub. Date: Aug. 24, 2006

(54) Material for heat-resistant electret and heat-resistant electret

(75) Inventors: Susumu Kawato, Yamatokoriyama-shi (JP); Yoshinori Ohta, Yamatokoriyama-shi (JP)

Correspondence Address: HAMRE, SCHUMANN, MUELLER & LARSON, P.C., P.O. BOX 2902-0902, MINNEAPOLIS, MN, 55402, US

(73) Assignee: Toho Kaseli Co., Ltd., Nara (JP)

(21) Appl. No.: 10/565,042

(22) PCT Filed: Jul. 21, 2004
(86) PCT No.: PCT/JP04/10683

§ 371 Date: Jan. 18, 2006

(30) Foreign Application Priority Data
Jul. 22, 2003 (JP) 2003-277808
Nov. 13, 2003 (JP) 2003-383818

(51) Int. Cl. B32B 15/08; C08F 214/26; C08F 14/26

(52) U.S. Cl. 428/422; 428/457; 526/247; 526/255

(57) ABSTRACT

An electret is produced using a heat resistant electret material containing a fluorocarbon resin, in which a modified polytetrafluoroethylene is used as the fluorocarbon resin. Also, an electret including a metal member and a resin film adhered to a surface of the metal member is produced, in which the resin film contains polytetrafluoroethylene and only a surface on the metal member side of the resin film has been subjected to an adhesion-improving treatment. Thus, it is possible to provide a heat resistant electret exhibiting excellent charge retention ability at high temperatures.

### TECHNICAL FIELD

The present invention relates to a heat resistant electret material and a heat resistant electret used for an earphone, a headphone, a microphone, or the like.

### BACKGROUND ART

Conventionally, as to an electret used for an earphone, a headphone, a microphone, or the like, a method of laminating a thermoplastic resin film capable of forming an electret on a metal sheet and then causing this resin to be an electret has been proposed (see JP 64(1989)-44010 A).

Also, there have been proposed a method of applying an organic solvent in which fine particles of a tetrafluoroethylene-hexafluoropropylene copolymer (FEP) are dispersed onto a metal plate so as to form a thin film and then causing the thin film to be an electret (see JP11 (1999)-150795 A) and a method of spraying a spray liquid in which FEP fine particles are dispersed onto a metal plate and then firing the spray liquid so as to cause it to be an electret (see JP2000-115895 A).

However, when the conventional electret using FEP is used to produce a microphone or the like, there arises a problem in that, if soldering is carried out by the use of a flow device or a reflow device, the function of the electret may be deteriorated due to a high temperature at the time of soldering. In particular, accompanying the recent trend toward a lead-free solder, the temperature at the time of soldering has become still higher to about 260° C., which may lead to a serious problem in that the function of the electret itself is lost.

### DISCLOSURE OF INVENTION

The present invention is intended to solve the above-described problems and to provide a heat resistant electret exhibiting excellent charge retention ability at high temperatures.

The present invention provides a heat resistant electret material containing a fluorocarbon resin. In this heat resistant electret material, the fluorocarbon resin is a modified polytetrafluoroethylene.

Furthermore, the present invention provides a heat resistant electret including a metal member and a heat resistant electret material that contains a fluorocarbon resin and is disposed on a surface of the metal member. In this heat resistant electret, the fluorocarbon resin is a modified polytetrafluoroethylene.

Furthermore, the present invention provides a heat resistant electret including a metal member and a resin film adhered to a surface of the metal member. In this heat resistant electret, the resin film contains polytetrafluoroethylene, a contact angle of a water droplet on one surface of the resin film is not greater than 110°, and said one surface of the resin film is adhered to the metal member.

Furthermore, the present invention provides a heat resistant electret including a metal member and a resin film adhered to a surface of the metal member. In this heat resistant electret, the resin film contains polytetrafluoroethylene, and only a surface on the metal member side of the resin film has been subjected to an adhesion-improving treatment.

### BRIEF DESCRIPTION OF THE DRAWINGS

FIG. 1 is a cross-sectional view showing an electret produced in Example A1.

FIG. 2 is a graph showing the relationship between a residual rate of a surface electric potential of an electret and a temperature.

FIG. 3 is a cross-sectional view of a laminate to be processed into an electret, which is produced in Example B1.

FIG. 4 is a graph showing the relationship between a residual rate of a surface electric potential and a time in a humidity test.

### DESCRIPTION OF THE INVENTION

### Embodiment 1

One example of a heat resistant electret material according to the present invention is a heat resistant electret material containing a fluorocarbon resin, in which a modified polytetrafluoroethylene (a modified PTFE) is used as the fluorocarbon resin.

In order to improve the charge retention ability of an electret at high temperatures, charge-trapping portions of an electret material need to be maintained up to a temperature in the vicinity of the melting point of the electret material. Specific examples of the charge-trapping portions include crystal defects formed inside the crystals of the fluorocarbon resin forming the electret material and interfaces between crystalline portions and amorphous portions. In the case where pure polytetrafluoroethylene (homo-PTFE) is used, voids are liable to be formed during the shaping process. Because of these voids, stress is reduced at high temperatures so that crystals of the homo-PTFE are liable to flow. As a result, the charge-trapping portions (e.g., interfaces between crystalline portions and amorphous portions) are damaged, resulting in deteriorated charge retention ability. Moreover, since homo-PTFE has a chemical structure without a side chain, crystal defects are not likely to occur. In contrast, in the case where a modified PTFE is used, voids are less liable to be formed during the shaping process. Besides, the modified PTFE has a chemical structure with a side chain. Accordingly, charge-trapping portions are maintained even at high temperatures, thus allowing an excellent charge retention ability to be achieved at high temperatures.

By using a fluorocarbon resin as the electret material, it is possible to provide the surface of the finished product with excellent characteristics such as an antifouling property, chemical resistance, water repellency, and weather resistance. Moreover, the flexibility of the electret is not damaged, and embossing and the like of the electret can be carried out relatively easily. It is to be noted here that the melting point of a modified PTFE (about 324° C.) is substantially the same as the melting point of homo-PTFE (about 330° C.), which is a typical fluorocarbon resin. Thus, it is possible to produce a microphone etc. using MEMS (Micro Electro Mechanical Systems) technology in which the processing temperature is about 300° C.

Preferably, the modified PTFE is a copolymer obtained by copolymerizing 99.0 to 99.999 mol % of tetrafluoroethylene and 1.0 to 0.001 mol % of perfluorovinyl ether. More preferably, the modified PTFE is a copolymer obtained by copolymerizing 99.5 to 99.99 mol % of tetrafluoroethylene and 0.5 to 0.01 mol % of perfluorovinyl ether. This is because, when tetrafluoroethylene and perfluorovinyl ether satisfying the above-described ranges are copolymerized, base crystals of the PTFE are deformed partially (i.e., crystal defects are formed) by perfluorovinyl ether, and electric charges can be retained more easily by these deformed portions.

When perfluorovinyl ether is less than 0.001 mol %, problems similar to those in the case of homo-PTFE will occur. On the other hand, when perfluorovinyl ether is more than 1.0 mol %, the melting point of the modified PTFE is lowered, so that the crystals of the modified PTFE are liable to flow at high temperatures. Thus, charge-trapping portions (e.g., interfaces between crystalline portions and amorphous portions) are damaged, resulting in deteriorated charge retention ability.

It is preferable that the heat resistant electret material has a dielectric constant of 2.1 or less. This is because, when the dielectric constant of the heat resistant electret material is in this range, the heat resistant electret material exhibits a low water absorption, so that the decrease in the surface charge can be prevented. Furthermore, it is preferable that the heat resistant electret material has a volume resistivity of at least 1.0×10¹⁸ Ω·cm. This is because, when the volume resistivity of the heat resistant electret material is in this range, the heat resistant electret material exhibits a low electric conductivity and thus is charged easily. It is to be noted here that the lower limit of the dielectric constant preferably is closer to 1, which is the dielectric constant of air.

One example of a heat resistant electret according to the present invention is configured so that the above-described heat resistant electret material is disposed on a surface of a metal member. By using a modified PTFE as the electret material, it is possible to provide an electret exhibiting excellent charge retention ability at high temperatures because the decrease in surface electric potential of the electret at high temperatures can be suppressed.

As the metal member, it is possible to use a metal plate, a metal sheet, or the like, for example.

The thickness of the heat resistant electret material is not particularly limited, but generally is in the range from 5 to 400 μm, preferably from 10 to 50 μm. When the thickness of the heat resistant electret material is in the above-described range, it is possible to provide a thin and small electret while maintaining the characteristics of the electret.

Furthermore, it is preferable that the metal member is formed of at least one selected from brass, aluminum, stainless steel, copper, titanium, nickel silver, phosphor bronze, an alloy thereof, and a metal having a surface layer formed by plating or evaporation coating therewith. This is because these metals have excellent corrosion resistance, electric conductivity, and workability.

As the metal member, it is preferable that a metal member with no fats and oils etc. attached thereon is used in the first place and that the metal member further is subjected to a surface treatment for improving the adhesion to the heat resistant electret material. The surface treatment can be carried out, for example, by forming a coating film through anode oxidization or a chemical conversion treatment or by the use of a coupling agent. Also, any other methods for improving the adhesion can be used as the surface treatment. For a similar purpose, it is preferable that a surface to be adhered to the metal member (hereinafter referred to as an “adhesion surface”) of the heat resistant electret material is subjected to a corona treatment, a sputtering treatment, a metallic sodium treatment, or the like.

One example of a method of producing a heat resistant electret of the present invention is carried out by adhering a film formed of the above-described heat resistant electret material to a surface of a metal member. As the metal member, a metal plate, a metal sheet, or the like can be used, for example. More specifically, the method is carried out in the following manner, for example. A film formed of a modified PTFE is provided. Using a compression roll having a pair of rolls, namely, a heating roll and a roll without a heat source, a metal plate and the film are adhered to each other through thermocompression bonding by inserting the metal plate and the film between the pair of rolls with the metal plate provided on the side of the heating roll and the film provided on the side of the roll without a heat source. The thermocompression bonding is carried out using a contact time of 1 to 3 seconds and a contact width of 1 to 20 mm.

Another example of a method of producing a heat resistant electret according to the present invention is carried out by coating a surface of a metal member with the above-described heat resistant electret material. More specifically, the method is carried out by, for example, coating a resin composition containing a modified PTFE and a solvent onto a metal member with a spray or the like and then firing the resin composition to form a resin layer containing the modified PTFE on a surface of the metal plate.

The laminate to be processed into an electret obtained by such methods is cut into a predetermined size, polarizing charged by a corona discharge or the like, and then subjected to an aging treatment. Then, it is used for an earphone, a headphone, a microphone, or the like.

By using a heat resistant electret of the present invention, it is possible to provide an electrostatic acoustic sensor exhibiting stable performance. Examples of the electrostatic acoustic sensor include a microphone, an earphone, a headphone, an otophone, an ultrasonic sensor, and an acceleration sensor.

Hereinafter, the present invention will be described more specifically by way of examples and comparative examples.

### Example A1

A 25 μm thick modified PTFE film was provided as an electret material. This modified PTFE film was formed of a copolymer obtained by copolymerizing 99.9 mol % of tetrafluoroethylene and 0.1 mol % of perfluoropropy vinyl ether. The modified PTFE film and a 0.2 mm thick brass plate were adhered to each other by thermocompression bonding using a heat roll and cut into a size of 50 cm×20 cm. Thus, an electret of Example A1 was produced. The thermocompression bonding was carried out at a temperature of 340° C. and at a pressure of 0.5 MPa.

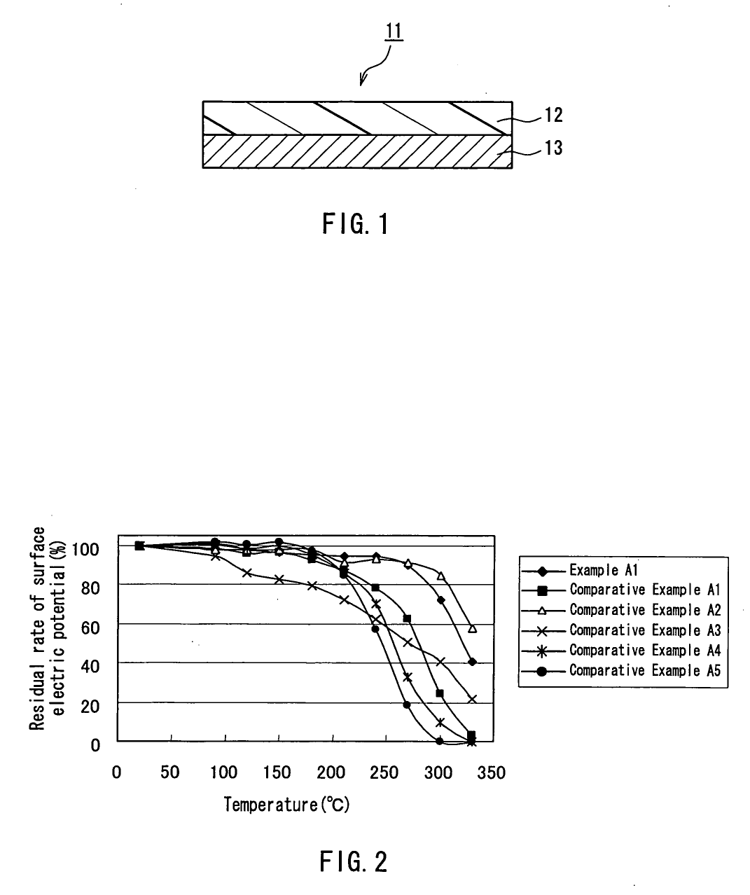

FIG. 1 is a cross-sectional view showing the electret produced in the present example. The electret 11 according to the present example is composed of the modified PTFE film 12 and the brass plate 13 adhered to each other by thermocompression bonding.

### Comparative Example A1

A 25 μm thick homo-PTFE film (“920-UL”: Nitto Denko Corporation) was provided as an electret material. This PTFE film and a 0.2 mm thick brass plate were adhered to each other by thermocompression bonding using a heat roll and cut into the same size as in Example A1. Thus, an electret of Comparative Example A1 was produced. The thermocompression bonding was carried out at a temperature of 340° C. and at a pressure of 0.5 MPa.

### Comparative Example A2

A 120 μm thick homo-PTFE non-woven fabric (DAIKIN INDUSTRIES, Ltd.) having a unit weight of 150 g/m² was provided as an electret material. This PTFE non-woven fabric and a 0.2 mm thick brass plate were adhered to each other by thermocompression bonding using a heat roll and cut into the same size as in Example A1. Thus, an electret of Comparative Example A2 was produced. The thermocompression bonding was carried out at a temperature of 360° C. and at a pressure of 0.6 MPa.

### Comparative Example A3

A 25 μm thick homo-PTFE film (“MSF-100”: Chukoh Chemical Industries, Ltd.) was provided as an electret material. This PTFE film and a 0.2 mm thick brass plate were adhered to each other by thermocompression bonding using a heat roll and cut into the same size as in Example A1. Thus, an electret of Comparative Example A3 was produced. The thermocompression bonding was carried out at a temperature of 340° C. and at a pressure of 0.5 MPa.

### Comparative Example A4

A 25 μm thick tetrafluoroethylene-hexafluoropropylene copolymer (FEP) film (“NF-0025”: DAIKIN INDUSTRIES, Ltd.) was provided as an electret material. This FEP film and a 0.2 mm thick brass plate were adhered to each other by thermocompression bonding using a heat roll and cut into the same size as in Example A1. Thus, an electret of Comparative Example A4 was produced. The thermocompression bonding was carried out at a temperature of 340° C. and at a pressure of 0.5 MPa.

### Comparative Example A5

A 25 μm thick tetrafluoroethylene (97 mol %)-perfluoroalkoxy vinyl ether (3 mol %) copolymer (PFA) film (“AF-0025”: DAIKIN INDUSTRIES, Ltd.) was provided as an electret material. This PFA film and a 0.2 mm thick brass plate were adhered to each other by thermocompression bonding using a heat roll and cut into the same size as in Example A1. Thus, an electret of Comparative Example A5 was produced. The thermocompression bonding was carried out at a temperature of 340° C. and at a pressure of 0.5 MPa.

### Example A2

An electret of Example A2 was produced in the same manner as in Example Al except that a 0.2 mm thick stainless steel plate was used instead of the brass plate.

### Comparative Example A6

An electret of Comparative Example A6 was produced in the same manner as in Comparative Example A1 except that a 0.2 mm thick stainless steel plate was used instead of the brass plate.

### Comparative Example A7

An electret of Comparative Example A7 was produced in the same manner as in Comparative Example A2 except that a 0.2 mm thick stainless steel plate was used instead of the brass plate.

### Comparative Example A8

An electret of Comparative Example A8 was produced in the same manner as in Comparative Example A3 except that a 0.2 mm thick stainless steel plate was used instead of the brass plate.

### Comparative Example A9

An electret of Comparative Example A9 was produced in the same manner as in Comparative Example A4 except that a 0.2 mm thick stainless steel plate was used instead of the brass plate.

### Comparative Example A10

An electret of Comparative Example A10 was produced in the same manner as in Comparative Example A5 except that a 0.2 mm thick stainless steel plate was used instead of the brass plate.

Next, with regard to each of the electrets of Examples A1 and A2 and Comparative Examples A1 to A10, the thickness and the surface roughness of the electret material adhered to the metal plate by thermocompression bonding and the residual rate of the surface electric potential of the electret were measured.

The thickness of the electret material was measured by measuring the thickness of the electret excluding the metal plate with a micrometer. The surface roughness of the electret material was measured with a surface roughness meter “SE-3500” manufactured by Kosaka Laboratory Ltd.

Furthermore, the residual rate of the surface electric potential of the electret was measured in the following manner. First, a sample collected from the electrets of Examples A1 and A2 and Comparative Examples A1 to A10 was subjected to a polarization treatment by a negative corona discharge at a temperature of 25° C., and the surface electric potential right after the polarization treatment was measured with an electrostatic voltmeter “Model 344” manufactured by Trek Japan KK. Then, the sample was allowed to stand at 270° C. or 300° C. for 10 minutes, and thereafter, the surface electric potential was measured in the same manner. Then, the surface electric potential after the electret had been allowed to stand at 270° C. or 300° C. for 10 minutes was calculated as a relative value (%) with respect to the reference value (100%) of the surface electric potential right after the electret had been subjected to the polarization treatment.

The measurement results are shown in Table 1. Furthermore, FIG. 2 shows the relationship between a residual rate of a surface electric potential and a temperature in Example A1 and Comparative Examples A1 to A5.

TABLE 1

| | | | | | | Residual | Residual |
|---|---|---|---|---|---|---|---|
| | | Surface roughness | | | | rate at | rate at |
| | Thickness (μm) | Ra (A) | Ra (max) | Ra (B) | Ra (max) | 270° C. (%) | 300° C. (%) |
| Ex. A1 | 24 | 0.21 | 1.7 | 0.16 | 1.67 | 88 | 80 |
| Ex. A2 | 24 | 0.25 | 1.97 | 0.21 | 1.72 | 78 | 39 |
| C. Ex. A1 | 24 | 0.34 | 3.33 | 0.35 | 3.28 | 58 | 28 |
| C. Ex. A2 | 120 | 5.92 | 36.42 | 4.91 | 33.77 | 87 | 58 |
| C. Ex. A3 | 24 | 0.23 | 2.17 | 0.26 | 2.28 | 57 | 30 |
| C. Ex. A4 | 23 | 0.51 | 4.17 | 0.4 | 2.78 | 13 | 1 |
| C. Ex. A5 | 23 | 0.46 | 2.78 | 0.58 | 3.14 | 0 | 0 |
| C. Ex. A6 | 24 | 0.32 | 3.16 | 0.34 | 3.6 | 42 | 18 |
| C. Ex. A7 | 120 | 6.93 | 46.61 | 6.69 | 55.81 | 72 | 60 |
| C. Ex. A8 | 24 | 0.2 | 1.58 | 0.2 | 1.63 | 53 | 33 |
| C. Ex. A9 | 23 | 0.5 | 3.71 | 0.44 | 3.19 | 8 | 1 |
| C. Ex. A10 | 23 | 0.54 | 4.49 | 0.57 | 3.76 | 0 | 0 |

Ex. = Example
C. Ex = Comparative Example
(A) = horizontal
(B) = vertical

As is apparent from Table 1, the surface electric potential residual rate obtained in Example A1 was higher than those obtained in Comparative Examples A1 to A5. Furthermore, the surface electric potential residual rate obtained in Example A2 was higher than those obtained in Comparative Examples A6 to A10. It is to be noted here that even when the thickness of the electret material was not greater than 25 μm, there was no significant influence on the surface electric potential residual rate.

In Examples A1 and A2, the surface roughness Ra (horizontal) and the surface roughness Ra (vertical) both were not greater than 0.5 μm. Thus, the electrets according to Examples A1 and A2 do not hinder the operation of a diaphragm when they are used for a microphone etc.

It is to be noted here that, although there was a certain increase in the residual rate in Comparative Examples A2 and A7, the surface roughnesses were much greater than 0.5 μm in these comparative examples. Thus, the electrets according to Comparative Examples A2 and A7 are not suitable for a microphone etc.

Although the above-described examples are directed to the case where a modified PTFE film is used as an electret material, it is also possible to coat a coating liquid (a dispersion) of a modified PTFE onto a metal member. Also, it is possible to add additives such as a low molecular fluorine compound and an inorganic substance, which can serve as a nucleating agent and an inhibitor, to a coating liquid of homo-PTFE. Considering the melting point, it is preferable to add perfluoroalkoxy vinyl ether to a coating liquid mainly composed of homo-PTFE. This increases interfaces of spherocrystals and crystal defects in the electret material, thus improving the charge retention ability at high temperatures.

### Embodiment 2

One example of a heat resistant electret according to the present invention is a heat resistant electret including a metal member and a resin film adhered to a surface of the metal member, in which the resin film is formed of polytetrafluoroethylene, a contact angle of a water droplet on one surface (a first principal surface) of the resin film is not greater than 110°, more preferably not greater than 60°, and said one surface (the first principal surface) of the resin film is adhered to the metal member.

When the contact angle of a water droplet on the surface (the first principal surface) on the metal member side of the resin film is not greater than 110°, the adhesion between the metal member and the resin film is improved, thereby allowing the performance of the electret to be maintained stably. Preferably, the contact angle of a water droplet is at least 50°. This is because, when the contact angle is in the above-described range, charge-trapping portions are stable, so that electric charges trapped therein are less liable to decrease.

By using a PTFE film as the resin film, it is possible to improve the charge retention ability of the electret at high temperatures. Also, by using a PTFE film as the resin film, it is possible to provide the surface of the finished product with excellent characteristics such as an antifouling property, chemical resistance, water repellency, and weather resistance. Moreover, the flexibility of the electret is not damaged, and embossing and the like of the electret can be carried out relatively easily.

Furthermore, when the contact angle of a water droplet on the surface (the second principal surface) on the side opposite to the metal member side of the resin film is at least 111°, the charge retention ability of the electret at high temperatures can be maintained more effectively.

It is to be noted that “a contact angle of a water droplet” as used in the present invention means a contact angle measured using distilled water.

Another example of a heat resistant electret according to the present invention is a heat resistant electret including a metal member and a resin film adhered to a surface of the metal member, in which the resin film is formed of PTFE, and only a surface on the metal member side of the resin film has been subjected to an adhesion-improving treatment.

This improves the adhesion between the metal member and the resin film, thereby allowing the performance of the electret to be maintained stably. Furthermore, by using a PTFE film as the resin film, it is possible to improve the charge retention ability of the electret at high temperatures. Also, by using a PTFE film as the resin film, it is possible to provide the surface of the finished product with excellent characteristics such as an antifouling property, chemical resistance, water repellency, and weather resistance. Moreover, the flexibility of the electret is not damaged, and embossing and the like of the electret can be carried out relatively easily.

By subjecting only one surface of the resin film to an adhesion-improving treatment, the charge retention ability of the electret can be maintained at high temperatures.

Examples of the adhesion-improving treatment include a chemical conversion treatment, a corona treatment, a plasma treatment, and a sputtering treatment. Among these, a chemical conversion treatment is preferable because it can be carried out using particularly simple manufacturing equipment.

To the heat resistant electret according to either of the examples given in the present embodiment, the following properties further can be imparted.

The resin film also can be formed using the same modified PTFE as used in Embodiment 1.

A 180° peel strength between the resin film and the metal member preferably is at least 0.5 N/cm, more preferably at least 1.0 N/cm. When the 180° peel strength is in the above-described range, the resin film does not separate from the metal member during a punching process or the like. It is to be noted here that the upper limit of the 180° peel strength is not particularly limited as long as the resin film does not separate from the metal member during a punching process or the like.

It is preferable that the resin film has a dielectric constant of 2.1 or less. This is because, when the dielectric constant of the resin film is in this range, the resin film exhibits a low water absorption, so that the decrease in the surface charge can be prevented. Furthermore, it is preferable that the resin film has a volume resistivity of at least 1.0×10¹⁸ Ω·cm. This is because, when the volume resistivity of the resin film is in this range, the resin film exhibits a low electric conductivity and thus is charged easily. It is to be noted here that the lower limit of the dielectric constant preferably is closer to 1, which is the dielectric constant of air.

The thickness of the PTFE film is not particularly limited, but generally is in the range from 5 to 400 μm, preferably from 10 to 50 μm. When the thickness of the PTFE film is in the above-described range, it is possible to provide a thin and small electret while maintaining the characteristics of the electret.

As the metal member, it is possible to use a metal plate, a metal sheet, or the like, for example. Furthermore, it is preferable that the metal member is formed of at least one selected from brass, aluminum, stainless steel, copper, titanium, nickel silver, phosphor bronze, an alloy thereof, and a metal having a surface layer formed by plating or evaporation coating therewith. This is because these metals have excellent corrosion resistance, electric conductivity, and workability.

One example of a method of producing a heat resistant electret according to the present invention includes the steps of subjecting one surface of a PTFE film to an adhesion-improving treatment and adhering the surface of the film that has been subjected to the adhesion-improving treatment to a surface of a metal member.

This improves the adhesion between the metal member and the resin film, thereby allowing an electret exhibiting stable performance to be provided. Furthermore, by using a PTFE film as the resin film, it is possible to provide an electret exhibiting improved charge retention ability at high temperatures. The melting point of PTFE is about 330° C. Thus, it is possible to produce a microphone, etc. using MEMS (Micro Electro Mechanical Systems) technology in which the processing temperature is about 300° C. Still further, by using a PTFE film as the resin film, it is also possible to provide the surface of the finished product with excellent characteristics such as an antifouling property, chemical resistance, water repellency, and weather resistance. Moreover, the flexibility of the electret is not damaged, and embossing and the like of the electret can be carried out relatively easily.

Examples of the adhesion-improving treatment include a chemical conversion treatment, a corona treatment, a plasma treatment, and a sputtering treatment. Among these, a chemical conversion treatment is preferable because it can be carried out using particularly simple manufacturing equipment.

As the metal member, it is possible to use a metal plate, a metal sheet, or the like, for example. As the metal member, it is preferable that a metal member with no fats and oils etc. attached thereon is used in the first place and that the metal member further is subjected to a surface treatment for improving the adhesion to the resin film. The surface treatment can be carried out, for example, by forming a coating film through anode oxidization or a chemical conversion treatment or by the use of a coupling agent. Also, any other methods for improving the adhesion can be used as the surface treatment.

The resin film can be adhered to the metal member in the following manner. Using a compression roll having a pair of rolls, namely, a heating roll and a roll without a heat source, the metal member and the resin film are adhered to each other through thermocompression bonding by inserting the metal member and the resin film between the pair of rolls with the metal member provided on the side of the heating roll and the resin film provided on the side of the roll without a heat source. The thermocompression bonding is carried out using a contact time of 1 to 3 seconds and a contact width of 1 to 20 mm.

The thus-obtained laminate to be processed into an electret is cut into a predetermined size, polarizing charged by a corona discharge or the like, and then subjected to an aging treatment. Thus, an electret is completed. The electret is used for an earphone, a headphone, a microphone, or the like.

By using a heat resistant electret of the present invention, it is also possible to provide an electrostatic acoustic sensor exhibiting stable performance. Examples of the electrostatic acoustic sensor include a microphone, an earphone, a headphone, an otophone, an ultrasonic sensor, and an acceleration sensor.

Hereinafter, the present invention will be described more specifically by way of examples and comparative examples.

### Example B1

A 25 μm thick PTFE film (“92 1UL”: Nitto Denko Corporation), only one surface of which had been treated so as to improve adhesion by a chemical conversion treatment, was provided. The contact angle of a water droplet on each surface of this PTFE film was measured with a contact angle meter (“CA-DT”: Kyowa Interface Science Co., Ltd.) using distilled water. As a result, it was found that the contact angle on the surface that had been subjected to the adhesion-improving treatment was 53° and the contact angle on the surface that had not been subjected to the adhesion-improving treatment was 118°.

Next, this PTFE film and a 0.2 mm thick stainless steel plate were adhered to each other via an epoxy adhesive by thermocompression bonding using a heat roll, with the surface of the PTFE film that had been subjected to the adhesion-improving treatment facing the stainless steel plate. The resultant laminate was cut into a size of 50 cm×20 cm. Thus, a laminate to be processed into an electret according to Example B1 was produced. The thermocompression bonding was carried out at a temperature of 340° C. and at a pressure of 0.5 MPa.

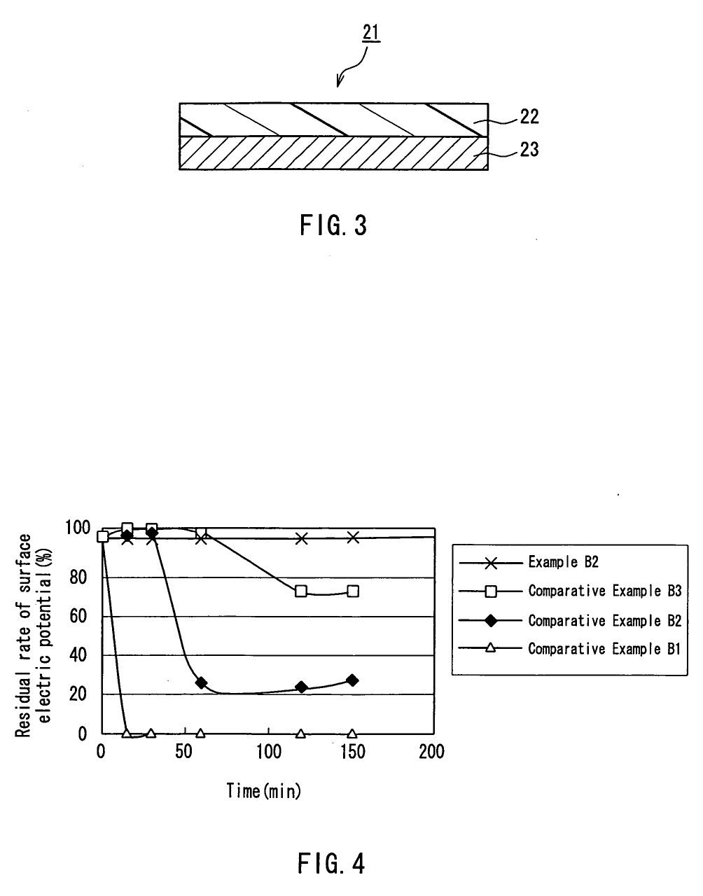

FIG. 3 is a cross-sectional view of the laminate to be processed into an electret obtained in the present example. The laminate 21 to be processed into an electret according to the present example is composed of the PTFE film 22 and the stainless steel plate 23 adhered to each other via the epoxy adhesive (not shown) by thermocompression bonding.

### Example B2

A chemical conversion coating agent (“Tetra Etch A”: Junkosha Inc.) was applied to one surface of a 25 μm thick PTFE film (“MSF-100”: Chukoh Chemical Industries, Ltd.), and the PTFE film was allowed to stand for 10 seconds. Thereafter, the PTFE film was washed with methanol and further with water, and then was dried. Through this chemical conversion treatment, the PTFE film, one surface of which had been subjected to an adhesion-improving treatment, was provided. The contact angle of a water droplet on each surface of this PTFE film was measured in the same manner as in Example B1. As a result, it was found that the contact angle on the surface that had been subjected to the adhesion-improving treatment was 44° and the contact angle on the surface that had not been subjected to the adhesion-improving treatment was 112°.

Next, a laminate to be processed into an electret according to Example B2 was produced in the same manner as in Example B 1 except that this PTFE film was used therein.

### Example B3

A 25 μm thick PTFE film (“MSF-100”: Chukoh Chemical Industries, Ltd.) was subjected to a plasma treatment using a plasma treatment apparatus (“PCB”: Nippo Electronics Co., Ltd.) with. a mask being provided on one surface of the PTFE film. The conditions of the plasma treatment were as follows: a frequency of a plasma generator was 40 kHz, a power source output was 5 kW, the gas used was a mixed gas of nitrogen and oxygen, a gas pressure was 33 Pa, an electrode temperature was 25° C., and an irradiation time was 5 seconds. After the plasma treatment, the mask was removed. Thus, the PTFE film, one surface of which had been treated so as to improve adhesion by the plasma treatment, was provided. The contact angle of a water droplet on each surface of this PTFE film was measured in the same manner as in Example B 1. As a result, it was found that the contact angle on the surface that had been subjected to the adhesion-improving treatment was 106° and the contact angle on the surface that had not been subjected to the adhesion-improving treatment was 118°.

Next, a laminate to be processed into an electret according to Example B3 was produced in the same manner as in Example B1 except that this PTFE film was used therein.

### Example B4

One surface of a 25 μm thick PTFE film (“MSF-100”: Chukoh Chemical Industries, Ltd.) was subjected to a corona discharge treatment using a corona discharge treatment apparatus (“POLYDYNE 1”: Navitas Co., Ltd.). The conditions of the corona discharge treatment were as follows: an applied voltage was 10 kV, an electrode-sample distance was 2 mm, and a processing speed was 4.5 m/min. Thus, the PTFE film, one surface of which had been treated so as to improve adhesion by the corona discharge treatment, was provided. The contact angle of a water droplet on each surface of this PTFE film was measured in the same manner as in Example B 1. As a result, it was found that the contact angle on the surface that had been subjected to the adhesion-improving treatment was 100° and the contact angle on the surface that had not been subjected to the adhesion-improving treatment was 124°.

Next, a laminate to be processed into an electret according to Example B4 was produced in the same manner as in Example B1 except that this PTFE film was used therein.

### Example B5

A laminate to be processed into an electret according to Example B5 was produced in the same manner as in Example B4 except that a 25 μm thick PTFE film (“920UL”: Nitto Denko Corporation) was used therein. The contact angle of a water droplet on each surface of this PTFE film was measured in the same manner as in Example B1. As a result, it was found that the contact angle on the surface that had been subjected to the adhesion-improving treatment was 102° and the contact angle on the surface that had not been subjected to the adhesion-improving treatment was 121°.

### Comparative Example B1

A laminate to be processed into an electret according to Comparative Example B 1 was produced in the same manner as in Example B2 except that both surfaces of the 25 μm thick PTFE film (“MSF-100”: Chukoh Chemical Industries, Ltd.) were subjected to the chemical conversion treatment. The contact angle of a water droplet on each surface of this PTFE film was measured in the same manner as in Example B1. As a result, it was found that the contact angle on the adhesion surface on the stainless steel plate side of the PTFE film was 49°and the contact angle on the non-adhesion surface on the side opposite to the stainless steel plate side of the PTFE film was 60°.

### Comparative Example B2

A laminate to be processed into an electret according to Comparative Example B2 was produced in the same manner as in Example B3 except that both surfaces of the 25 μm thick PTFE film (“MSF100”: Chukoh Chemical Industries, Ltd.) were subjected to the plasma treatment without being masked. The contact angle of a water droplet on each surface of this PTFE film was measured in the same manner as in Example B1. As a result, it was found that the contact angle on the adhesion surface on the stainless steel plate side of the PTFE film was 108° and the contact angle on the non-adhesion surface on the side opposite to the stainless steel plate side of the PTFE film was 107°.

### Comparative Example B3

A laminate to be processed into an electret according to Comparative Example B3 was produced in the same manner as in Example B4 except that both surfaces of the 25 μm thick PTFE film (“MSF-100”: Chukoh Chemical Industries, Ltd.) were subjected to the corona discharge treatment. The contact angle of a water droplet on each surface of this PTFE film was measured in the same manner as in Example B1. As a result, it was found that the contact angle on the adhesion surface on the stainless steel plate side of the PTFE film was 109° and the contact angle on the non-adhesion surface on the side opposite to the stainless steel plate side of the PTFE film was 102°.

### Comparative Example B4

A laminate to be processed into an electret according to Comparative Example B4 was produced in the same manner as in Example B2 except that the 25 μm thick PTFE film (“MSF-100”: Chukoh Chemical Industries, Ltd.) was not at all subjected to the chemical conversion treatment. The contact angle of a water droplet on each surface of this PTFE film was measured in the same manner as in Example B1. As a result, it was found that the contact angle on the adhesion surface on the stainless steel plate side of the PTFE film was 118° and the contact angle on the non-adhesion surface on the side opposite to the stainless steel plate side of the PTFE film was 125°.

### Comparative Example B5

A laminate to be processed into an electret according to Comparative Example B5 was produced in the same manner as in Example B1 except that a 25 μm thick FEP film (“NF-0025”: DAIKIN INDUSTRIES, Ltd.) either surface of which had not been subjected an adhesion-improving treatment was used therein. The contact angle of a water droplet on each surface of this FEP film was measured in the same manner as in Example B1. As a result, it was found that the contact angle on the adhesion surface on the stainless steel plate side of the FEP film was 111° and the contact angle on the non-adhesion surface on the side opposite to the stainless steel plate side of the FEP film was 118°.

Next, with regard to each of the laminates to be processed into an electret according to Examples B1 to B5 and Comparative Examples B1 to B5, a 180° peel strength between the stainless steel plate and the resin film and a residual rate of the surface electric potential of the laminate to be processed into an electret were measured. Also, a pressing test and a cleaning test were carried out so as to simulate a pressing process and a cleaning process in the actual production of the electret.

The 180° peel strength was measured using a peel strength tester (“AGS-H”: Shimadzu Corporation).

Furthermore, the residual rate of the surface electric potential of each of the laminates to be processed into an electret was measured in the following manner. First, the laminate to be processed into an electret was subjected to a polarization treatment by a negative corona discharge at a temperature of 25° C., and the surface electric potential right after the polarization treatment was measured with an electrostatic voltmeter (“Model 344”: Trek Japan KK). Then, the laminate was allowed to stand at 270° C. for 10 minutes, and thereafter, the surface electric potential was measured in the same manner. Then, the surface electric potential after the laminate had been allowed to stand at 270° C. for 10 minutes was calculated as a relative value (%) with respect to the reference value (100%) of the surface electric potential right after the electret had been subjected to the polarization treatment. The conditions of the corona discharge treatment were as follows: an applied voltage was −5 kV, a grid voltage was −200 V, an electrode-sample distance was 2 mm, and a processing period was 10 seconds.

The pressing test was carried out in the following manner. First, using a 20-ton press, each of the 50 cm×20 cm laminates to be processed into an electret according to Examples B1 to B5 and Comparative Examples B1 to B5 was punched out into a disc shape having a diameter of 4.5 mm. Then, the separation of the resin film from the stainless steel plate at an edge portion of the thus-obtained electret was observed.

The cleaning test was carried out in the following manner. The electret obtained by the above-described pressing was cleaned ultrasonically in acetone for 5 minutes using an ultrasonic cleansing apparatus (“UT604R”: Sharp Corporation). Then, infiltration of the acetone between the stainless steel plate and the resin film in an edge portion of the electret was observed.

The results are shown in Table 2. In Table 2, the results of the pressing test and the cleaning test were indicated as follows based on the observation of the electret after each test: “excellent” indicates that neither separation of the resin film nor infiltration of the acetone was observed; “good” indicates that the separation of the resin film was not observed, but some infiltration of the acetone was observed; and “not good” indicates that separation of the resin film and infiltration with the acetone both were observed.

For reference purposes, Table 3 shows a surface roughness Ra of the adhesion surface and the non-adhesion surface of the resin film used in each of Examples B 1 to B5 and Comparative Examples B 1 to B5. This is because the surface roughness affects the contact angle. The surface roughness was measured using a surface roughness meter “SE-3500” manufactured by Kosaka Laboratory Ltd.

TABLE 2

| | Contact angle on | Contact angle on | 180° peel | Residual rate of | |
|---|---|---|---|---|---|
| | adhesion | non-adhesion | strength | surface electric | Pressing test |
| | surface | surface | (N/cm) | potential (%) | Cleaning test |
| Ex. B1 | 53° | 118° | 3.1 | 40 | excellent |
| Ex. B2 | 44° | 112° | 3.5 | 34 | excellent |
| Ex. B3 | 106° | 118° | 0.8 | 24 | good |
| Ex. B4 | 100° | 124° | 0.7 | 36 | good |
| Ex. B5 | 102° | 121° | 0.7 | 30 | good |
| C. Ex. B1 | 49° | 60° | 3.1 | 6 | excellent |
| C. Ex. B2 | 108° | 107° | 1.2 | 13 | excellent |
| C. Ex. B3 | 109° | 102° | 0.5 | 43 | good |
| C. Ex. B4 | 118° | 125° | 0.3 | 61 | not good |
| C. Ex. B5 | 111° | 118° | 3.5 | 0 | excellent |

Ex. = Example
C. Ex = Comparative Example

TABLE 3

| | Surface roughness | Surface roughness |
|---|---|---|
| | of adhesion | of non-adhesion |
| | surface Ra (μm) | surface Ra (μm) |
| Example B1 | 0.76 | 0.41 |
| Example B2 | 0.77 | 0.34 |
| Example B3 | 0.59 | 0.31 |
| Example B4 | 0.71 | 0.36 |
| Example B5 | 0.35 | 0.42 |
| Comparative Example B1 | 0.28 | 0.24 |
| Comparative Example B2 | 0.28 | 0.44 |
| Comparative Example B3 | 0.26 | 0.31 |
| Comparative Example B4 | 0.31 | 0.50 |
| Comparative Example B5 | 0.23 | 0.61 |

As is apparent from Table 2, the laminates to be processed into an electret according to Examples B 1 to B5 all exhibited a surface electric potential residual rate of at least 20% and generally exhibited satisfactory results in the pressing test and the cleaning test. In particular, the laminates according to Examples B 1 and B2 that had been subjected to the chemical conversion treatment exhibited the peel strengths equivalent to that of the laminate using the conventional FEP according to Comparative Example B5. In contrast, in the laminate using the untreated PTFE according to Comparative Example B4, infiltration of the acetone due to the separation of the PTFE film was observed in the pressing test and the cleaning test. Furthermore, the laminate using FEP according to Comparative Example B5 exhibited a surface electric potential residual rate of 0%. Thus, the laminates according to Comparative Examples B4 and B5 both were unsuitable as an electret.

Next, a humidity test was performed with regard to the electrets according to Example B2 and Comparative Examples B1 to B3. The humidity test was carried out by placing the laminates to be processed into an electret according to Example B2 and Comparative Examples B1 to B3 in an atmosphere at a temperature of 60° C. and a humidity of 80% and measuring the residual rate of the surface electric potential at predetermined time intervals in the same manner as in the above. That is, a sample collected from the laminates to be processed into an electret according to Example B2 and Comparative Examples B1 to B3 was subjected to a polarization treatment by a negative corona discharge at a temperature of 25° C., and the surface electric potential right after the polarization treatment was measured with an electrostatic voltmeter (“Model 344”: Trek Japan KK). Then, the laminate to be processed into an electret was placed in an atmosphere at a temperature of 60° C and a humidity of 80%. After a lapse of a certain period, the surface electric potential of the laminate was measured in the same manner. Then, the surface electric potential after the lapse of the certain period was calculated as a relative value (%) with respect to the reference value (100%) of the surface electric potential right after the electret had been subjected to the polarization treatment. The conditions of the corona discharge treatment were the same as those described in the above. The results of the humidity test were shown in FIG. 4.

As is apparent from FIG. 4, in the laminate according to Example B2 in which only the adhesion surface of the PTFE film had been subjected to the chemical conversion treatment, there was little decrease in the residual rate of the surface electric potential even after a lapse of 150 minutes. In contrast, in the laminates according to Comparative Examples B1 to B3, the residual rate of the surface electric potential decreased with the passage of time. In particular, in the laminate according to Comparative Example B1 in which both the surfaces of the PTFE film had been subjected to the chemical conversion treatment, the residual rate of the surface electric potential decreased abruptly immediately after the start of the humidity test. The reason for this is considered to be as follows. Because both the surfaces of the PTFE film had been subjected to the chemical conversion treatment, the wettability of the surface of the resultant laminate was extremely high, so that electric charges were neutralized by moisture adhered to the surface of the laminate.

### INDUSTRIAL APPLICABILITY

As described above, the present invention can provide an electret exhibiting excellent charge retention ability at high temperatures. Moreover, by the use of an electret according to the present invention, various kinds of electrostatic acoustic sensors such as a microphone, an earphone, a headphone, an otophone, an ultrasonic sensor, and an acceleration sensor can be provided. Therefore, the present invention has a significant industrial value.

1. A heat resistant electret material comprising a fluorocarbon resin,
wherein the fluorocarbon resin is a modified polytetrafluoroethylene.

2. The heat resistant electret material according to claim 1, wherein the modified polytetrafluoroethylene is a copolymer obtained by copolymerizing 99.0 to 99.999 mol % of tetrafluoroethylene and 1.0 to 0.001 mol % of perfluorovinyl ether.

3. The heat resistant electret material according to claim 1, which has a dielectric constant of 2.1 or less and a volume resistivity of at least 1.0×10¹⁸ Ω·cm.

4. A heat resistant electret comprising a metal member and a heat resistant electret material that comprises a fluorocarbon resin and is disposed on a surface of the metal member,
wherein the fluorocarbon resin is a modified polytetrafluoroethylene.

5. The heat resistant electret according to claim 4, wherein the modified polytetrafluoroethylene is a copolymer obtained by copolymerizing 99.0 to 99.999 mol % of tetrafluoroethylene and 1.0 to 0.001 mol % of perfluorovinyl ether.

6. The heat resistant electret according to claim 4, wherein the heat resistant electret material has a dielectric constant of 2.1 or less and a volume resistivity of at least 1.0×10¹⁸ Ω·cm.

7. The heat resistant electret according to claim 4, wherein the metal member is formed of at least one selected from brass, aluminum, stainless steel, copper, titanium, nickel silver, phosphor bronze, an alloy thereof, and a metal having a surface layer formed by plating or evaporation coating therewith.

8. The heat resistant electret according to claim 4, wherein the metal member is a metal plate.

9. A heat resistant electret comprising a metal member and a resin film adhered to a surface of the metal member,
wherein the resin film comprises polytetrafluoroethylene,
a contact angle of a water droplet on one surface of the resin film is not greater than 110°, and
said one surface of the resin film is adhered to the metal member.

10. The heat resistant electret according to claim 9, wherein a 180° peel strength between the metal member and the resin film is at least 0.5 N/cm.

11. The heat resistant electret according to claim 9, wherein the resin film has a dielectric constant of 2.1 or less and a volume resistivity of at least 1.0×10¹⁸ Ω·cm.

12. The heat resistant electret according to claim 9, wherein the metal member is a metal plate.

13. The heat resistant electret according to claim 9, wherein the metal member is formed of at least one selected from brass, aluminum, stainless steel, copper, titanium, nickel silver, phosphor bronze, an alloy thereof, and a metal having a surface layer formed by plating or evaporation coating therewith.

14. A heat resistant electret comprising a metal member and a resin fim adhered to a surface of the metal member,
wherein the resin film comprises polytetrafluoroethylene, and
only a surface on the metal member side of the resin film has been subjected to an adhesion-improving treatment.

15. The heat resistant electret according to claim 14, wherein the adhesion-improving treatment is at least one treatment selected from a chemical conversion treatment, a corona treatment, a plasma treatment, and a sputtering treatment.

16. The heat resistant electret according to claim 14, wherein a 180° peel strength between the metal member and the resin film is at least 0.5 N/cm.

17. The heat resistant electret according to claim 14, wherein the resin film has a dielectric constant of 2.1 or less and a volume resistivity of at least 1.0×10¹⁸ Ω·cm.

18. The heat resistant electret according to claim 14, wherein the metal member is a metal plate.

19. The heat resistant electret according to claim 14, wherein the metal member is formed of at least one selected from brass, aluminum, stainless steel, copper, titanium, nickel silver, phosphor bronze, an alloy thereof, and a metal having a surface layer formed by plating or evaporation coating therewith.
